(19) United States
(12) Patent Application Publication
(10) Pub. No.: US 2023/0234129 A1
(43) Pub. Date: Jul. 27, 2023

(54) STRUCTURALLY INTEGRATED HEAT-EXCHANGERS

(71) Applicant: Divergent Technologies, Inc., Los Angeles, CA (US)

(72) Inventors: John Russell BUCKNELL, El Segundo, CA (US); Antonio Bernerd Martinez, El Segundo, CA (US); Jon Paul Gunner, Palos Verdes Estates, CA (US); Kevin Robert Czinger, Santa Monica, CA (US)

(21) Appl. No.: 17/855,396

(22) Filed: Jun. 30, 2022

Related U.S. Application Data
(60) Provisional application No. 63/302,951, filed on Jan. 25, 2022.

(51) Int. Cl. B22F 5/10; B33Y 30/00; B33Y 80/00; F28F 1/02; B21D 53/06; F28D 1/053

(52) U.S. Cl. CPC B22F 5/106; B33Y 30/00; B33Y 80/00; F28F 1/022; B21D 53/06; F28D 1/05333; F28F 2260/02

(57) ABSTRACT

Techniques for structurally integrated heat exchangers are presented herein. A heat exchanger in accordance with an aspect of the present disclosure comprises a structure configured to enclose a volume for storing a first fluid, and to connect to a load. The heat exchanger further comprises a first and a second header first arranged in opposing inner walls of the structure. The heat exchanger further comprises one or more load-bearing struts extending to connect the first and second headers within the volume and configured to pass a second fluid through the volume for transferring heat to the first fluid, the second fluid configured to cool a different component in the vehicle.

### CROSS-REFERENCE TO RELATED APPLICATIONS

This application claims priority to U.S. Provisional Application No. 63/302,951 titled “STRUCTURALLY INTEGRATED HEAT-EXCHANGERS,” filed Jan. 25, 2022, which is assigned to the assignee hereof, and incorporated herein by reference in its entirety as if fully set forth herein.

### BACKGROUND

### Field

The present disclosure relates generally to techniques for heat exchangers, and more specifically to heat-exchangers integrated into one or more components and/or structures of the vehicle.

### Background

Three-dimensional (3-D) printing, also referred to as additive manufacturing (AM), presents new opportunities to more efficiently build structures, such as automobiles, aircraft, boats, motorcycles, busses, trains and the like. Applying AM processes to industries that produce these products has proven to produce a structurally more efficient transport structure. For example, an automobile produced using 3-D printed components can be made stronger, lighter, and consequently, more fuel efficient. Moreover, AM enables manufacturers to 3-D print parts that are much more complex and that are equipped with more advanced features and capabilities than parts made via traditional machining and casting techniques.

Despite these recent advances, a number of obstacles remain with respect to the practical implementation of AM techniques in transport structures and other mechanized assemblies. For instance, regardless of whether AM is used to produce various components of such devices, manufacturers typically rely on labor-intensive and expensive techniques such as welding, riveting, etc., to join components together, such as nodes used in a transport structure. The deficiencies associated with welding and similar techniques are equally applicable to components, such as a vehicle gear case, that are currently too large to 3-D print in a single AM step. A given 3-D printer is usually limited to rendering objects having a finite size, often dictated by the available surface area of the 3-D printer's build plate and the allowable volume the printer can accommodate. In these instances, manufacturers are often relegated to building the component using the traditional, expensive and time-consuming machining techniques. Alternatively, manufacturers may 3-D print a number of subcomponents and combine them to form a complete, functional component or assembly.

### SUMMARY

Several aspects of techniques for integrating one heat-exchangers into one or more components and/or structures of a vehicle will be described more fully hereinafter.

A heat exchanger in accordance with an aspect of the present disclosure comprises a structure configured to enclose a volume for storing a first fluid, and to connect to a load. The heat exchanger further comprises a first and a second header first arranged in opposing inner walls of the structure. The heat exchanger further comprises one or more load-bearing struts extending to connect the first and second headers within the volume and configured to pass a second fluid through the volume for transferring heat to the first fluid, the second fluid configured to cool a different component in the vehicle.

A heat exchanger in accordance with an aspect of the present disclosure comprises an elongated structure that includes first ports adjacent respective proximate and distal ends thereof, the first ports being configured to enable a first fluid to flow through the structure. The heat exchanger further comprises first and second headers coupled to respective ends of the structure. The heat exchanger further comprises a plurality of microtubes extending through the structure to connect the first and second headers to thereby enable a second fluid to flow through the microtubes between respective second ports arranged in the first and second headers, wherein the structure includes a load-bearing structure for coupling to a load.

A heat exchanger in accordance with an aspect of the present disclosure comprises a load-bearing shell structure that extends longitudinally to include first ports arranged adjacent respective proximate and distal ends thereof, the first ports configured to enable a first fluid to flow through the shell structure. The heat exchanger further comprises first and second headers arranged at opposite ends of the shell structure. The heat exchanger further comprises a plurality of tubes extending through the shell structure to connect the first and second headers, the first and second headers each having second ports to enable a second fluid to flow through the tubes between the first and second headers to cool the first fluid, wherein at least one of the first or second headers connects to a load.

It will be understood that other aspects of joining nodes and subcomponents with adhesive will become readily apparent to those skilled in the art from the following detailed description, wherein it is shown and described only several embodiments by way of illustration. As will be appreciated by those skilled in the art, the joining of additively manufactured nodes and subcomponents can be realized with other embodiments without departing from the invention. Accordingly, the drawings and detailed description are to be regarded as illustrative in nature and not as restrictive.

### BRIEF DESCRIPTION OF THE DRAWINGS

Various aspects of apparatuses and methods for joining nodes and subcomponents with adhesive will now be presented in the detailed description by way of example, and not by way of limitation, in the accompanying drawings, wherein:

FIGS. 1A-1D illustrate respective side views of a 3-D printer system in accordance with an aspect of the present disclosure;

FIG. 1E illustrates a functional block diagram of a 3-D printer system in accordance with an aspect of the present disclosure;

FIG. 2 shows a side cross-sectional view illustrating an heat-exchanger in accordance with an aspect of the present disclosure; and

FIG. 3 shows a side cross-sectional view illustrating an heat-exchanger in accordance with an aspect of the present disclosure.

### DETAILED DESCRIPTION

The detailed description set forth below in connection with the drawings is intended to provide a description of exemplary embodiments of joining additively manufactured nodes and subcomponents, and it is not intended to represent the only embodiments in which the invention may be practiced. The term “exemplary” used throughout this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the invention to those skilled in the art. However, the invention may be practiced without these specific details. In some instances, well-known structures and components may be shown in block diagram form, or omitted entirely, in order to avoid obscuring the various concepts presented throughout this disclosure.

The use of additive manufacturing in the context of joining two or more parts provides significant flexibility and cost saving benefits that enable manufacturers of mechanical structures and mechanized assemblies to manufacture parts with complex geometries at a lower cost to the consumer. The joining techniques described in the foregoing relate to a process for connecting AM parts and/or commercial off the shelf (COTS) components. AM parts are printed three-dimensional (3-D) parts that are printed by adding layer upon layer of a material based on a preprogramed design. The parts described in the foregoing may be parts used to assemble a transport structure such as an automobile. However, those skilled in the art will appreciate that the manufactured parts may be used to assemble other complex mechanical products such as vehicles, trucks, trains, motorcycles, boats, aircraft, and the like, and other mechanized assemblies, without departing from the scope of the invention.

In one aspect of the disclosure, a joining technique for additively manufactured nodes is disclosed. A node is an example of an AM part. A node may be any 3-D printed part that includes a socket or other mechanism (e.g., a feature to accept these parts) for accepting a component such as a tube and/or a panel. The node may have internal features configured to accept a particular type of component. Alternatively or conjunctively, the node may be shaped to accept a particular type of component. A node, in some embodiments of this disclosure may have internal features for positioning a component in the node's socket. However, as a person having ordinary skill in the art will appreciate, a node may utilize any feature comprising a variety of geometries to accept any variety of components without departing from the scope of the disclosure. For example, certain nodes may include simple insets, grooves or indentations for accepting other structures, which may be further bound via adhesives, fasteners or other mechanisms.

Nodes as described herein may further include structures for joining tubes, panels, and other components for use in a transport structure or other mechanical assembly. For example, nodes may include joints that may act as an intersecting points for two or more panels, connecting tubes, or other structures. To this end, the nodes may be configured with apertures or insets configured to receive such other structures such that the structures are fit securely at the node. Nodes may join connecting tubes to form a space frame vehicle chassis. Nodes may also be used to join internal or external panels and other structures. In many cases, individual nodes may need to be joined together to accomplish their intended objectives in enabling construction of the above described structures. Various such joining techniques are described below.

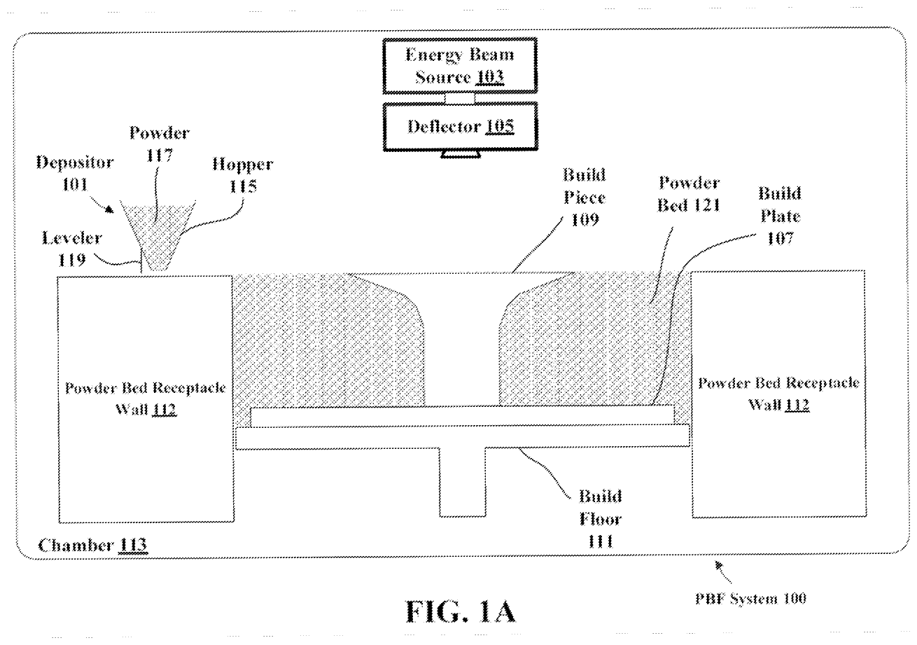

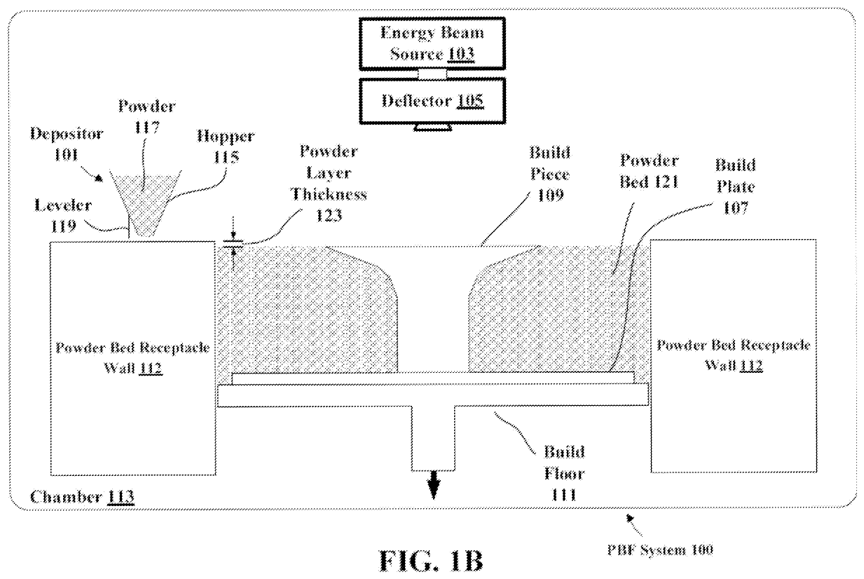

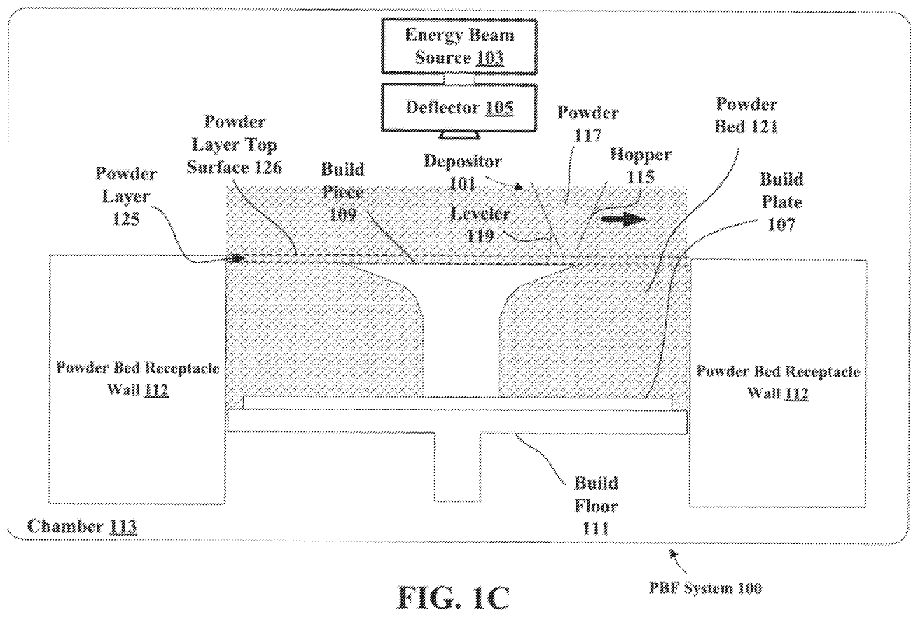

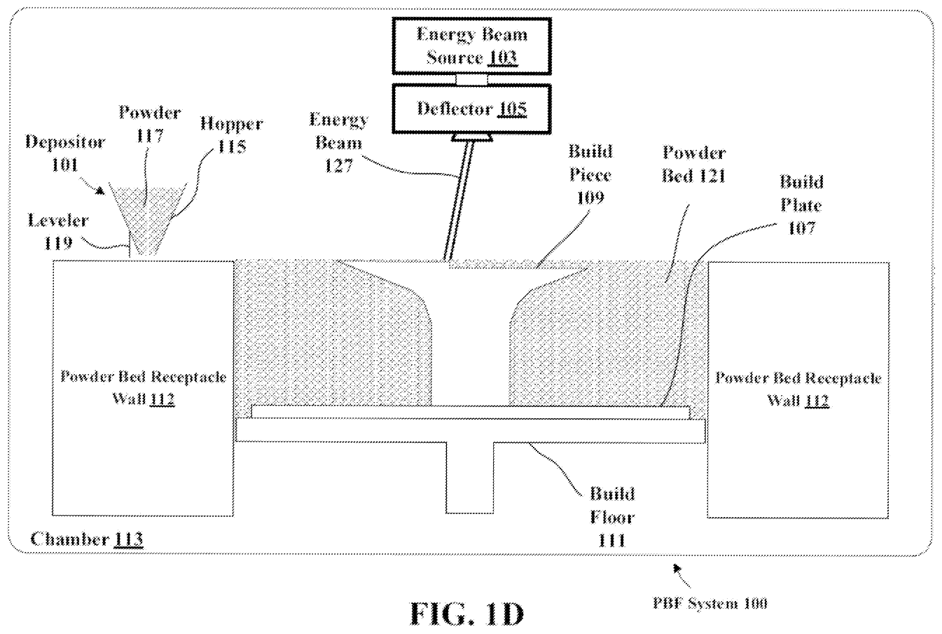

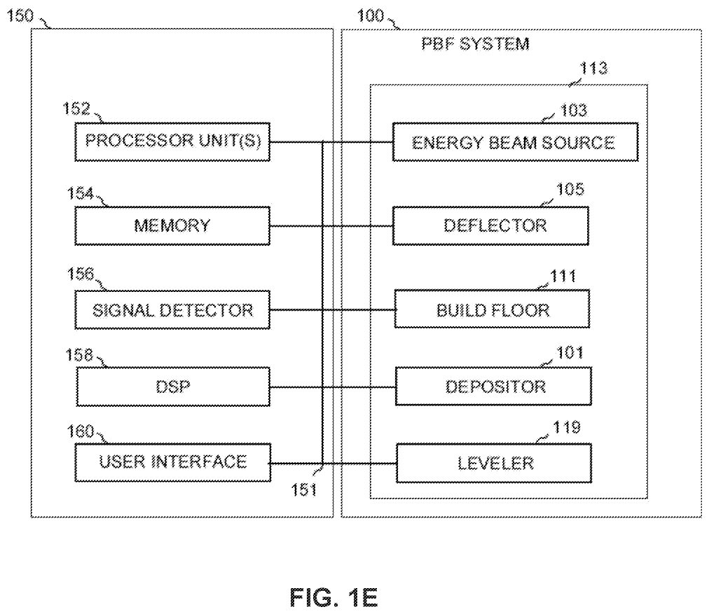

FIGS. 1A-D illustrate respective side views of an exemplary 3-D printer system.

In this example, the 3-D printer system is a powder-bed fusion (PBF) system 100. FIGS. 1A-D show PBF system 100 during different stages of operation. The particular embodiment illustrated in FIGS. 1A-D is one of many suitable examples of a PBF system employing principles of this disclosure. It should also be noted that elements of FIGS. 1A-D and the other figures in this disclosure are not necessarily drawn to scale, but may be drawn larger or smaller for the purpose of better illustration of concepts described herein. PBF system 100 can include a depositor 101 that can deposit each layer of metal powder, an energy beam source 103 that can generate an energy beam, a deflector 105 that can apply the energy beam to fuse the powder material, and a build plate 107 that can support one or more build pieces, such as a build piece 109. Although the terms “fuse” and/or “fusing” are used to describe the mechanical coupling of the powder particles, other mechanical actions, e.g., sintering, melting, and/or other electrical, mechanical, electromechanical, electrochemical, and/or chemical coupling methods are envisioned as being within the scope of the present disclosure.

PBF system 100 can also include a build floor 111 positioned within a powder bed receptacle. The walls of the powder bed receptacle 112 generally define the boundaries of the powder bed receptacle, which is sandwiched between the walls 112 from the side and abuts a portion of the build floor 111 below. Build floor 111 can progressively lower build plate 107 so that depositor 101 can deposit a next layer. The entire mechanism may reside in a chamber 113 that can enclose the other components, thereby protecting the equipment, enabling atmospheric and temperature regulation and mitigating contamination risks. Depositor 101 can include a hopper 115 that contains a powder 117, such as a metal powder, and a leveler 119 that can level the top of each layer of deposited powder.

Referring specifically to FIG. 1A, this figure shows PBF system 100 after a slice of build piece 109 has been fused, but before the next layer of powder has been deposited. In fact, FIG. 1A illustrates a time at which PBF system 100 has already deposited and fused slices in multiple layers, e.g., 150 layers, to form the current state of build piece 109, e.g., formed of 150 slices. The multiple layers already deposited have created a powder bed 121, which includes powder that was deposited but not fused.

FIG. 1B shows PBF system 100 at a stage in which build floor 111 can lower by a powder layer thickness 123. The lowering of build floor 111 causes build piece 109 and powder bed 121 to drop by powder layer thickness 123, so that the top of the build piece and powder bed are lower than the top of powder bed receptacle wall 112 by an amount equal to the powder layer thickness. In this way, for example, a space with a consistent thickness equal to powder layer thickness 123 can be created over the tops of build piece 109 and powder bed 121.

FIG. 1C shows PBF system 100 at a stage in which depositor 101 is positioned to deposit powder 117 in a space created over the top surfaces of build piece 109 and powder bed 121 and bounded by powder bed receptacle walls 112. In this example, depositor 101 progressively moves over the defined space while releasing powder 117 from hopper 115. Leveler 119 can level the released powder to form a powder layer 125 that has a thickness substantially equal to the powder layer thickness 123 (see FIG. 1B). Thus, the powder in a PBF system can be supported by a powder material support structure, which can include, for example, a build plate 107, a build floor 111, a build piece 109, walls 112, and the like. It should be noted that the illustrated thickness of powder layer 125 (i.e., powder layer thickness 123 (FIG. 1B)) is greater than an actual thickness used for the example involving 150 previously-deposited layers discussed above with reference to FIG. 1A.

FIG. 1D shows PBF system 100 at a stage in which, following the deposition of powder layer 125 (FIG. 1C), energy beam source 103 generates an energy beam 127 and deflector 105 applies the energy beam to fuse the next slice in build piece 109. In various exemplary embodiments, energy beam source 103 can be an electron beam source, in which case energy beam 127 constitutes an electron beam. Deflector 105 can include deflection plates that can generate an electric field or a magnetic field that selectively deflects the electron beam to cause the electron beam to scan across areas designated to be fused. In various embodiments, energy beam source 103 can be a laser, in which case energy beam 127 is a laser beam. Deflector 105 can include an optical system that uses reflection and/or refraction to manipulate the laser beam to scan selected areas to be fused.

In various embodiments, the deflector 105 can include one or more gimbals and actuators that can rotate and/or translate the energy beam source to position the energy beam. In various embodiments, energy beam source 103 and/or deflector 105 can modulate the energy beam, e.g., turn the energy beam on and off as the deflector scans so that the energy beam is applied only in the appropriate areas of the powder layer. For example, in various embodiments, the energy beam can be modulated by a digital signal processor (DSP).

FIG. 1E illustrates a functional block diagram of a 3-D printer system in accordance with an aspect of the present disclosure.

In an aspect of the present disclosure, control devices and/or elements, including computer software, may be coupled to PDF system 100 to control one or more components within PDF system 100. Such a device may be a computer 150, which may include one or more components that may assist in the control of PDF system 100. Computer 150 may communicate with a PDF system 100, and/or other AM systems, via one or more interfaces 151. The computer 150 and/or interface 151 are examples of devices that may be configured to implement the various methods described herein, that may assist in controlling PDF system 100 and/or other AM systems.

In an aspect of the present disclosure, computer 150 may comprise at least one processor unit 152, memory 154, signal detector 156, a digital signal processor (DSP) 158, and one or more user interfaces 160. Computer 150 may include additional components without departing from the scope of the present disclosure.

The computer 150 may include at least one processor unit 152, which may assist in the control and/or operation of PDF system 100. The processor unit 152 may also be referred to as a central processing unit (CPU). Memory 154, which may include both read-only memory (ROM) and random access memory (RAM), may provide instructions and/or data to the processor 504. A portion of the memory 154 may also include non-volatile random access memory (NVRAM). The processor 152 typically performs logical and arithmetic operations based on program instructions stored within the memory 154. The instructions in the memory 154 may be executable (by the processor unit 152, for example) to implement the methods described herein.

The processor unit 152 may comprise or be a component of a processing system implemented with one or more processors. The one or more processors may be implemented with any combination of general-purpose microprocessors, microcontrollers, digital signal processors (DSPs), floating point gate arrays (FPGAs), programmable logic devices (PLDs), controllers, state machines, gated logic, discrete hardware components, dedicated hardware finite state machines, or any other suitable entities that can perform calculations or other manipulations of information.

The processor unit 152 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, RS-274 instructions (G-code), numerical control (NC) programming language, and/or any other suitable format of code). The instructions, when executed by the one or more processors, cause the processing system to perform the various functions described herein.

The computer 150 may also include a signal detector 156 that may be used to detect and quantify any level of signals received by the computer 150 for use by the processing unit 152 and/or other components of the computer 150. The signal detector 156 may detect such signals as energy beam source 103 power, deflector 105 position, build floor 111 height, amount of powder 117 remaining in depositor 101, leveler 119 position, and other signals. The computer 150 may also include a DSP 158 for use in processing signals received by the computer 150. The DSP 158 may be configured to generate instructions and/or packets of instructions for transmission to PDF system 100.

The computer 150 may further comprise a user interface 160 in some aspects. The user interface 160 may comprise a keypad, a pointing device, and/or a display. The user interface 160 may include any element or component that conveys information to a user of the computer 150 and/or receives input from the user.

The various components of the computer 150 may be coupled together by a bus system 151. The bus system 151 may include a data bus, for example, as well as a power bus, a control signal bus, and a status signal bus in addition to the data bus. Components of the computer 150 may be coupled together or accept or provide inputs to each other using some other mechanism.

Although a number of separate components are illustrated in FIG. 1E, one or more of the components may be combined or commonly implemented. For example, the processor unit 152 may be used to implement not only the functionality described above with respect to the processor unit 152, but also to implement the functionality described above with respect to the signal detector 156, the DSP 158, and/or the user interface 160. Further, each of the components illustrated in FIG. 1E may be implemented using a plurality of separate elements.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, compact disc (CD) ROM (CD-ROM) or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, digital versatile disc (DVD), floppy disk and Blu-ray disc where disks usually reproduce data magnetically, while discs reproduce data optically with lasers. Thus, computer readable medium comprises a non-transitory computer readable medium (e.g., tangible media).

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

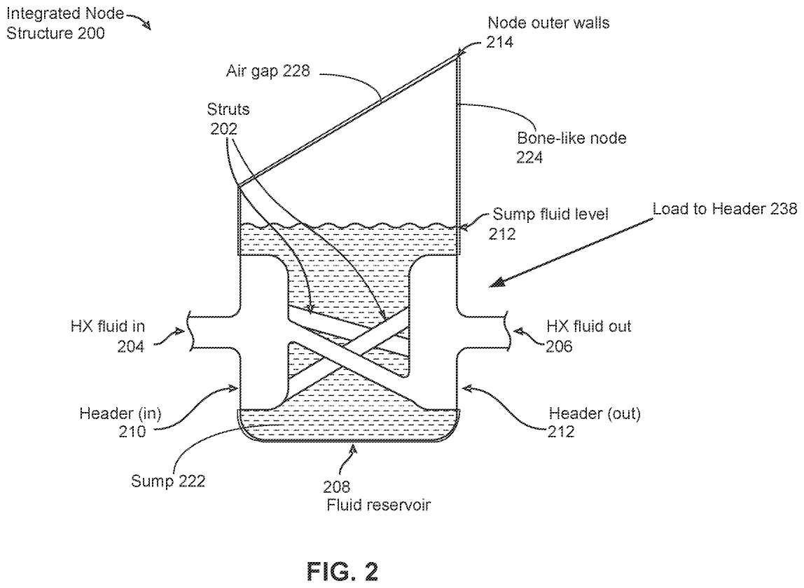

Turning now to FIG. 2, there is shown a side cross-sectional view illustrating heat exchanger.

In FIG. 2, integrated node structure 200 is illustrated. In some implementations, the integrated node structure 200 may be a bone-like node, a box-like node, and/or a combination of both. The integrated node structure 200 may include outer walls 214. The bone-like node with the outer walls 214 may create a closed volume sump as shown in FIG. 2. In some implementations, integrated node structure 200 of FIG. 2 may be additively manufactured.

The node structure 200 may include a fluid reservoir 208 as shown in FIG. 2. In some implementations, to provide isolation for the fluid reservoir, the integrated node structure 200 may include more than one outer walls 214. For example, the outer walls 214 of the integrated node structure 200 may be double walled. In some implementations, there may be an insulating air gap 228 provided in between two or more outer walls 214. The air gap 228 provides insulation and prevents transmission of heat from the fluid reservoir to other components of the vehicle. The node structure 200 may include a include sump 222. In some implementations, a portion of the node structure 200 may include a sump fluid, as shown by sump fluid level 212 in FIG. 2.

The node structure 200 may include headers 210, 212. Header 210 is an in header and header 212 is an out header. Header 210 is configured to receive heat exchanger fluid 204 to the node structure 200. In some implementations, header 210 may be a collector that distributes to many struts 202 and/or tubes. In some implementations, header 210 may be a collector of one to many struts and/or tubes. The header 210 may collect heat exchanger fluid and distribute it via the multiple struts 202 and/or tubes to other portions of node structure 200.

Header 212 is configured to carry out the heater exchanger fluid 206 from node structure 200 to other portions of the vehicle. In some implementations, header 212 may be a collector that collects from many tubes to the collector of the header 212. In some implementations, header 212 may be a collector of many struts 202 and/or tubes to one. Header 212 may collect the heat exchanger fluid from many struts 202 and/or tubes of the node structure 200 to the collector of the header 212. In some implementations, the headers 210, 212 may be hollow cylinders. As shown in FIG. 2, headers 210, 212 may be arranged in opposing inner walls of the node structure 200. The headers 210, 212 may be connected to a load of the vehicle. In some implementations, the load may be connected to the node structure 200 via a pin joint. In some implementations, the pin joint may be arranged on the headers 210, 212.

In some implementations, heat exchanger fluid 204 may be a dieelectric fluid, oil, water, and the like. As shown in FIG. 2, from the header 210, the heat exchanger fluid is carried through the struts 202. The struts 202 may be tubes configured to carry fluid. For example, the struts 202 may be configured to have a hollow portion. In some implementations, the struts 202 may be configured to encase an array of microtubes. In some implementation each strut 202 may encase a microtube. The struts 202 may be load bearing struts and may be configured to resist longitudinal compression and/or tension. The struts 202 may be connected to headers 210, 212 as shown in FIG. 2.

As shown in FIG. 2, a collector and/or an input port of header 210 may be connected to multiple struts 202 in the node structure 200, and a collector and/or an output port of header 212 may be configured to receive from the struts 202. As such, the interior of struts 202 form the primary coolant loop of the fluid reservoir 208 while also separating it from the fluid in the fluid reservoir 208. Additionally, the struts 202 of node structure 200 may be part of a mechanical framework but also configured to carry and/or pass fluid from one portion of the node structure 200 to another portion of the node structure 200.

As described above, the node structure 200 may be a combination of bone-like node and box-like node. The box-like structure of the node structure 200 may allow for the fluid retention in the fluid reservoir 208 of the node structure 200, and the bone-like structure of the node structure 200 allows for the struts 202 to be integrated within the node structure 200 and transmit the fluid and the load from one to the other portion of the node structure 200.

The transmission of heat exchanger fluid from an input port of the header 210 to an output port of the header 212 allows for transfer of heat. In some implementations, header 210 may receive hot heat exchange fluid in 204, which may be cooled down via sump 222 and the heat exchange fluid out 206 may be carried to the another device in the vehicle.

Accordingly, as shown in FIG. 2, the heat exchangers are integrated in a node structure of the vehicle. As such, the heat exchagers are structurally integrated within a vehicle, which may further reduce the overall weight of the vehicle and allow for more efficient transportation by the vehicle

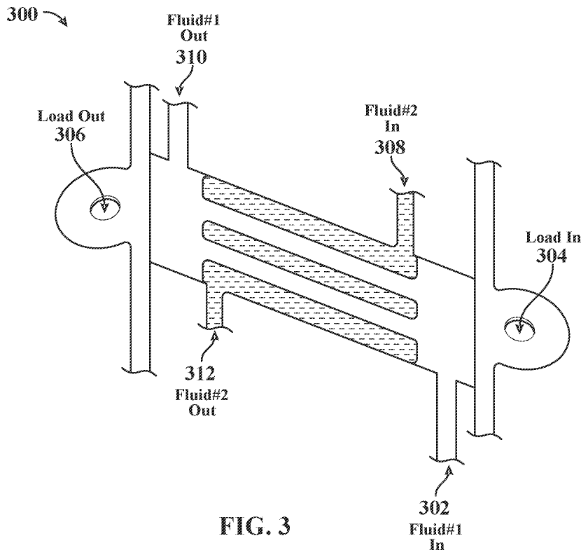

Turning now to FIG. 3, there is shown a side cross-sectional view illustrating another heat exchanger.

In FIG. 3, there is shown a strut 300. The strut 300 may connect two points in space and/or two points of a vehicle. The strut 300 may include a load in 304 and a load out 306. The strut 300 may connect to a load of the vehicle via the load in 304 and load out 306. In some implementations, the load may be a frame rail. In some implementations, as shown in FIG. 3, the strut 300 may be an elongated structure.

The strut 300 may include headers 302, 310 and 308, 312. Header 302 may be an in header for a first heat exchange fluid and header 310 may be an out header for the first exchange fluid. The header 308 may be an in header for a second heat exchange fluid and header 312 may be out header for the second heat exchanger fluid.

Header 302 and 310 may include ports to enable the first heat exchange fluid to transmit through the strut 300 as shown in FIG. 3. Header 308, 312 may include ports to enable the second heat exchange fluid to transmit through the strut 300 as shown in FIG. 3. Headers 302, 310 may be connected to a first set or a first array of microtubes. The first set or the first array of microtubes may extend through the strut 300. Headers 308, 312 may be connected to a second set or a second array of microtubes. The second set or the second array of microtubes may extend through the strut 300.

The headers 302, 310, 308, 312 and the connected microtubes may include and/or form a load-bearing structure. In some implementations, the microtubes may be encased in a structure configured to be load-bearing and resist longitudinal and/or lateral compression or tension. In some implementations, the microtubes may have a major diameter and a minor diameter. The microtubes may comprise an wall between the major and the minor diameters. In some implementations, a first and/or a second heat exchange fluid may be transmitted within a minor diameter and the other heat exchange fluid may be transmitted between the major and the minor diameters.

In some implementations, the microtubes may be further stabilized by connected microtubes via cross-links and/or fins. For example, two or more adjacent microtubes may be further stabilized by connecting them via the cross-links and/or the fins. The cross-links and/or the fins may be distributed throughout the strut 300 in a manner without interfering the flow of the heat exchange fluids between the microtubes.

In some implementations, a second heat exchange fluid (or a first heat exchange fluid) may be a hot fluid and may transfer heat to the first heat exchange fluid (or a second heat exchange fluid) within the strut 300. The second heat exchange fluid (or a first heat exchange fluid) is configured to cool a separate component of the vehicle after is exits from the out port of the header 312 (or the out port of the header 310). The strut 300 may be additively manufactured.

In some implementations, the strut 300 may be encased in a shell. The shell may be a load-bearing structure.

The previous description is provided to enable any person skilled in the art to practice the various aspects described herein. Various modifications to these exemplary embodiments presented throughout this disclosure will be readily apparent to those skilled in the art, and the concepts disclosed herein may be applied to other techniques for printing and joining nodes and subcomponents. Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. A heat exchanger for a vehicle, comprising:
a structure configured to enclose a volume for storing a first fluid, and to connect to a load;
first and second headers arranged in opposing inner walls of the structure; and
a plurality of load-bearing struts extending to connect the first and second headers within the volume and configured to pass a second fluid through the volume for transferring heat to the first fluid, the second fluid configured to cool a different component in the vehicle.

2. The heat exchanger of claim 1, wherein the load comprises a frame rail.

3. The heat exchanger of claim 1, being three-dimensional (3D) printed.

4. The heat exchanger of claim 1, wherein the structure comprises portions of a box-like node.

5. The heat exchanger of claim 1, wherein the plurality of load-bearing struts, and the first and second headers, comprise portions of a bone-like node.

6. The heat exchanger of claim 1, wherein the structure is further configured to connect to another load on a different side of the structure from where the load is connected, and to support the load and the another load.

7. The heat exchanger of claim 1, wherein at least one of the plurality of struts encases within the strut an array of microtubes configured to pass the second fluid through the volume.

8. The heat exchanger of claim 1, wherein at least a portion of walls enclosing the volume in the structure are overlaid by outer walls to form a region defining a gap between the walls and the outer walls.

9. The heat exchanger claim 8, wherein the gap comprises an air gap.

10. The heat exchanger of claim 1, wherein the first header is configured to route the second fluid from an input port disposed on the first header through a plurality of struts.

11. The heat exchanger of claim 10, wherein the second header is configured to receive the second fluid from the plurality of struts and to route the second fluid to an output port disposed on the second header.

12. The heat exchanger of claim 1, wherein the load is connected to the structure via a pin joint arranged on the first or second headers.

13. The heat exchanger of claim 1, wherein:
at least one of the first or second headers has a generally cylindrical shape,
the plurality of struts are connected to the cylindrical-shaped header at one of the ends of the header; and
a diameter of a cylinder corresponding to the header is greater than a length of the cylinder.

14. A heat exchanger, comprising:
an elongated structure that includes first ports adjacent respective proximate and distal ends thereof, the first ports being configured to enable a first fluid to flow through the structure;
first and second headers coupled to respective ends of the structure; and
a plurality of microtubes extending through the structure to connect the first and second headers to thereby enable a second fluid to flow through the microtubes between respective second ports arranged in the first and second headers,
wherein the structure includes a load-bearing structure for coupling to a load.

15. The heat exchanger of claim 14, wherein the load comprises a frame rail.

16. The heat exchange of claim 14, wherein the headers and the microtubes collectively include a load-bearing tube structure.

17. The heat exchanger of claim 14, being three-dimensional (3D) printed.

18. The heat exchanger of claim 14, further comprising a plurality cross-links connected between adjacent ones of the plurality of microtubes, the cross-links being configured to stabilize the tubes.

19. The heat exchanger of claim 18, wherein the cross-links are distributed in a manner sufficient to stabilize the microtubes without interfering with a flow of the first fluid between the microtubes.

20. The heat exchanger of claim 14, wherein at least one of the first or second headers includes a pin joint for coupling to the load.

21. The heat exchanger of claim 14, wherein the elongated structure includes a cylindrical shape.

22. The heat exchanger of claim 14, wherein:
the second fluid is configured to transfer heat to the first fluid within the structure; and
the second fluid is configured to cool a separate component within a vehicle after exiting the second port.

23. The heat exchanger of claim 14, wherein the elongated structure includes a load-bearing shell structure.

24. A heat exchanger, comprising:
a load-bearing shell structure that extends longitudinally to include first ports arranged adjacent respective proximate and distal ends thereof, the first ports configured to enable a first fluid to flow through the shell structure;
first and second headers arranged at opposite ends of the shell structure; and
a plurality of tubes extending through the shell structure to connect the first and second headers, the first and second headers each having second ports to enable a second fluid to flow through the tubes between the first and second headers to cool the first fluid,
wherein at least one of the first or second headers connects to a load.

25. The heat exchanger of claim 24, wherein the plurality of tubes is a load-bearing structure.

26. The heat exchanger of claim 24, wherein the load includes a frame rail.

27. The heat exchanger of claim 24, wherein the plurality of tubes includes one or more three-dimensional (3D)-printed microtubes.

28. The heat exchanger of claim 27, further comprising a plurality of 3D-printed cross-links distributed at different locations across adjacent microtubes.
